(19) United States
(12) Patent Application Publication
(10) Pub. No.: US 2011/0039089 A1
(43) Pub. Date: Feb. 17, 2011

(54) POLYMER-BASED CELLULAR STRUCTURE COMPRISING CARBON NANOTUBES, METHOD FOR ITS PRODUCTION AND USES THEREOF

(75) Inventors: Nour-Eddine El Bounia, Orthez (FR); Thomas Roussel, Pau (FR)

Correspondence Address: ARKEMA INC.;PATENT DEPARTMENT - 26TH FLOOR, 2000 MARKET STREET, PHILADELPHIA, PA, 19103-3222, US

(73) Assignee: Toyota Jidosha Kabushiki Kaisha, Toyota-Shi (JP)

(21) Appl. No.: 11/910,747

(22) PCT Filed: Apr. 14, 2006
(86) PCT No.: PCT/FR2006/000821

§ 371 Date: Sep. 29, 2010

(30) Foreign Application Priority Data
Apr. 27, 2005 (FR) 0504231
Dec. 29, 2005 (US) 60754888

(51) Int. Cl. B32B 3/26; C08J 9/00; B82Y 99/00

(52) U.S. Cl. 428/313.3; 521/60; 977/742

(57) ABSTRACT

The invention relates to a polymer-based cellular structure comprising carbon nanotubes. To a method for its production and uses thereof.

### FIELD OF THE INVENTION

The present invention relates to a polymeric cellular structure comprising carbon nanotubes (CNT), process for its preparation and uses thereof in the production of a lightweight structure.

### PRIOR ART AND TECHNICAL PROBLEM

Polymer foams are generating increasing interest. Thanks to their unique microcellular structure, these expanded plastics have superior mechanical properties such as impact resistance, hardness and fatigue life, when compared with the raw polymer. These excellent properties make it possible for them to constantly find uses in a very large number of applications. For example, currently polystyrene foams produced in plate form by extrusion using supercritical fluids (a so-called “direct gassing” process), find applications in the field of food packaging, thermal insulation and domestic refrigeration (refrigerators).

Processes for the preparation of polymeric cellular structure or polymer foams, in particular polystyrene foams, for obtaining lightweight materials, are well known (WO2001/89794, WO1998/01501, WO2002/46284, WO2005/019310). In general, these materials are electrically and thermally insulating due to the nature of the polymers currently employed, and these materials can be used in numerous domestic or industrial fields of application, such as packaging, insulation, coverings, structural materials.

In the field of thermal insulation based on expanded polymers, it is well known to a person skilled in the art that the thermal conductivity of the foam depends on several parameters: the intrinsic density of the polymer, the cell size, the number of cells, the density of the foam and the thermal conductivity of the expansion gas that it is sought to retain inside the cells. In general, the gas has a tendency to diffuse through the cell walls, leading to a reduction in the insulation rate. Management of these different parameters allows high-performance foam to be obtained.

Moreover, carbon nanotubes are known and used for their excellent electrical and thermal conductivity properties as well as their mechanical properties. Thus they are increasingly used as additives to give these electrical, thermal and/or mechanical properties to materials, in particular those of the polymeric type, either expanded or not (WO 03/085681, WO 91/03057; U.S. Pat. No. 5,744,235, U.S. Pat. No. 5,445,327,U.S. Pat. No. 5,466,3230).

Applications for carbon nanotubes are found in many fields, in particular in electronics (depending on the temperature and their structure, they can be conductors, semi-conductors or insulators), in mechanical engineering, for example for reinforcing composite materials (carbon nanotubes are one hundred times stronger and six times lighter than steel) and electromechanical engineering (they can be extended or contracted by the injection of charge).

Examples which can be mentioned are the use of carbon nanotubes in polymer compositions intended for packaging electronic components, the manufacture of fuel lines, antistatic coverings or coatings, in thermistors, electrodes for supercapacitors, etc.

Well known in this field are organic conductive compositions which are generally formulations based on polymeric substances of which at least one component is of a semi-crystalline type such as for example polyethylene and containing conductive additives, the best known being carbon black (J. of Pol. Sci. Part B-Vol. 41, 3094-3101 (2003)) or PVDF (US 20020094441 A1, U.S. Pat. No. 6,640,420).

Therefore there is still a need to develop new lightweight materials such as for example polymer-based foams.

### SUMMARY OF THE INVENTION

The purpose of the invention is to propose novel polymeric cellular structures comprising carbon nanotubes.

Development of these novel polymer cellular structures makes it possible to extend the range of the properties of corresponding lightweight materials. In particular, it can be mentioned that materials are obtained which have very diverse properties mechanically, rheologically, electrically, thermally etc. In particular, the advantage of these novel structures is that they have smaller cell structures than those of the polymeric structures of the prior art, with a density at least equivalent to or even less than the density of the structures of the prior art. Other advantages will become apparent on reading the detailed description of the invention.

A subject of the invention is a polymeric cellular structure comprising carbon nanotubes, in particular a structure in which the percentage by weight of carbon nanotubes in the polymer structure is less than 60%, preferably comprised between 10 and 50% or also preferably comprised between 0.1 and 3%.

In the structure according to the invention the average size of the cells is less than 150 microns, preferably comprised between 20 and 80 microns.

In the structure according to the invention the void volume is at least 50%, preferably comprised between 50% and 99%.

In the structure according to the invention the bulk density is less than 100 Kg/m³, preferably comprised between 10 and 60 Kg/m³.

According to an embodiment, the polymer is selected from the group constituted by thermoplastic or thermosetting (co)polymers, elastomers and resins, preferably chosen from PVDF, EVA, PEBA, PA or even better, the polymer chosen is a polystyrene or a polyurethane.

According to another embodiment the structure according to the invention comprises the residues of an expansion agent, in particular the expansion agent is selected from the group constituted by the organic or inorganic compounds, liquid or gaseous, of solid chemical components capable of generating cells by decomposition, gaseous compounds or a mixture of these.

According to another embodiment in the structure according to the invention, the cell walls also comprise pores.

A subject of the invention is also, the use of a structure such as described above in the fields of food packaging, insulation, the materials for lightweight structures, the production of membranes, electrodes.

A subject of the invention is also the process for the preparation of a polymeric cellular structure comprising the steps of

a) preparing the CNT/polymer composite mixture;

b) solubilization, during which the expansion agent which is solubilized in the mixture is introduced;

c) subjecting the mixture to the chemical or physical conditions for creating cells in the polymerised structure.

According to a particular embodiment, the expansion agent used in the process is a supercritical gas, preferably supercritical CO₂ or a fluorinated gas chosen from chlorofluorocarbons (CFC), hydrochlorofluorocarbons (HCFC) hydrofluorocarbons (HFC).

According to a variant, in the above process the mixture of step c) is subjected to a decompression in order to create the cells.

According to another variant of the process, the polymer originating from step c) is subjected to carbonization followed by a step of graphitization at a temperature greater than 1000° C.

### BRIEF DESCRIPTION OF THE FIGURES

FIG. 1 shows the development of the viscosity as a function of the shear rate of different CNT/polystyrene lacqrene 1450 mixtures marketed by Total Petrochemicals.

FIGS. 2 and 3 show the development of the cell diameter and the density of the foam as a function of the different % of CNT incorporated and as a function of the expansion temperature used in the foaming process.

FIG. 4 shows the orientation of the CNTs during expansion via the biaxial flow of the molten polymer.

### DETAILED DESCRIPTION OF THE EMBODIMENTS OF THE INVENTION

The invention provides a cellular polymeric structure comprising carbon nanotubes.

The carbon nanotubes used in the invention have an aspect ratio (L/D) greater than or equal to 5 and preferably greater than or equal to 50 and advantageously greater than or equal to 100. In general, carbon nanotubes have a tubular structure with a diameter less than 100 nm, preferentially comprised between 0.4 and 50 nm and/or in general with a length greater than 5 times their diameter, preferentially greater than 50 times their diameter and advantageously comprised between 100 to 100000 or also comprised of 1000 to 10000 times their diameter.

The carbon nanotubes are constituted by an allotropic variety of carbon in an sp2 configuration consisting of a long single-, double- or multi-walled tube with aromatic rings attached to each other, aggregated or not.

When the nanotube is constituted by a single tube, this will be called single-wall, when there are two tubes this will be called double-wall. Beyond this, it will be called multi-wall. The external surface of the nanotubes can be uniform or textured.

By way of example, single-wall, double-wall or multi-wall nanotubes, nanofibres, etc. can be mentioned.

These nanotubes can be treated chemically or physically in order to purify them or to functionalize them in order to confer on them novel properties of dispersion and interaction with the components of the formulation such as polymer matrices, elastomers, thermosetting resins, oils, greases, water- or solvent-based formulations such as paints, adhesives, varnishes.

The carbon nanotubes can be prepared according to different processes, such as the electric arc process (C. Journet et al. in Nature (London), 388 (1997) 756, the CVD gas phase process, Hipco (P. Nicolaev et al. in Chem. Phys. Lett., 1999, 313, 91), the laser process (A. G. Rinzler et al. in Appl. Phys. A, 1998, 67, 29), or any process producing tubular shapes which are empty or filled with substances containing carbon or other than carbon. Reference can be made for example more particularly to the documents WO 86/03455, WO 03/002456 for the preparation of distinct or non-aggregated multi-wall carbon nanotubes.

The polymeric cellular structure comprises one or more polymers chosen from the polymers and copolymers, in particular thermoplastic, thermosetting, thermoplastic resins, acrylic polymers, methacrylic polymers.

By way of example, styrenic polymers, polyolefines, polyurethanes, ethylene copolymers such as Evatanes and Lotryls marketed by Arkema, rubbers such as those for sealing can be mentioned.

As examples of thermoplastic resins, the following can be mentioned:
the resins:
acrylonitrile-butadiene-styrene (ABS),
acrylonitrile-ethylene/propylene-styrene (AES),
methylmethacrylate-butadiene-styrene (MBS),
acrylonitrile-butadiene-methylmethacrylate-styrene (ABMS),
acrylonitrile-n-butylacrylate-styrene (AAS),
modified polystyrene gums,
the resins:

polyethylene, polypropylene, polystyrene, polymethyl-methacrylate, polyvinyl chloride, cellulose acetate, polyamide, polyester, polyacrylonitrile, polycarbonate, polyphenyleneoxide, polycetone, polysulphone, polyphenylenesulphide,
the resins:

fluorinated, siliconated, polyimide, polybenzimidazole.

As examples of thermosetting resins, the resins based on phenol, urea, melamine, xylene, diallylphthalate, epoxy, aniline, furane, polyurethane, etc can be mentioned.

As examples of thermoplastic elastomers which can be used in the present invention, elastomers of polyolefin type, styrene type such as styrene-butadiene-styrene block co-polymers or styrene-isoprene-styrene block co-polymers or their hydrogenated form, elastomers of PVC, urethane, polyester, polyamide (PA) type, thermoplastic elastomers of polybutadiene type such as 1,2-polybutadiene or trans-1,4-polybutadiene resins; elastomers of polyethylene type such as methylcarboxylate-polyethylene, ethylene-vinylacetate (EVA), ethylene-ethylacrylate copolymers, chlorinated polyethylene, thermoplastic elastomers of fluorinated type such as polyvinylidene fluorides (PVDF), polyether esters and polyether amides such as for example those of polyetherbloc polyamine (PEBA) type etc. can also be mentioned.

Poly(1-vinyl pyrrolidone-co-vinyl acetate), poly(1-vinyl pyrrolidone-co-acrylic acid), poly(1-vinylpyrrolidone-co-dimethylaminoethyl methacrylate), polyvinyl sulphate, poly(sodium styrene sulphonic acid-co-maleic), dextran, dextran sulphate, gelatin, bovine serum albumin, poly(methyl acid methacrylate-co-ethyl acrylate), polyallyl amine, and their combinations can also be mentioned. Preferably, polymers chosen from the PVDFs, EVAs, PEBAs, PAs are used.

The polymeric cell structure is porous. The structure has a total void volume or a total volume of pores of at least 50%, preferably greater than 80% and preferably greater than 92% or also preferably comprised between 50 and 99%. The pores or cells of the structure can be open or closed according to the application envisaged.

The average size of the cells or of the pores d₅₀ is defined by the average diameter of 50% of the cells by volume. The average diameter of the cellules d₅₀ is less than 150 microns, preferably less 100 microns, preferably less than 80 microns and preferably also less than 10 microns. The average diameter of the d₅₀ cells is comprised between 5 and 80 microns, preferably comprised between 30 and 50 microns.

The porosity value is defined by the ratio of the void volume to the geometric volume of the structure. It can be associated with the ideas of true density dₜᵣᵤₑ, which is the theoretical density of the bulk material and bulk density d_{bulk} of the material comprising the pores, accessible or not. The relationship linking the true porosity to the true density and to the bulk density is as follows: Porosity=1−(d_{bulk}/dₜᵣᵤₑ). The total porosity is deduced from measurement of the bulk density using a pycnometer.

The structure has a bulk density of less than 100 Kg/m³, preferably comprised between 10 and 60 Kg/m³. The density is measured by a pycnometer.

The process for the preparation of a polymeric cellular structure namely the foaming process is well known in the field of polymer foams. The foaming process can be of a physical nature based on the use of expansion agents chosen from the group constituted by liquid or gaseous, organic compounds or inorganic compounds or their mixture. Preferably, the expansion agent is chosen from the group of volatile organic compounds constituted by the hydrocarbons, the chlorofluorocarbons (CFC), the hydrochlorofluorocarbons (HCFC), the hydrofluorocarbons (HFC), etc.

Preferably also, the expansion agent is chosen from the group of inorganic compounds constituted by gases, in particular nitrogen, helium, carbon dioxide, supercritical fluids, in particular CO₂, hydrocarbons, chlorofluorocarbons (CFC), hydrochlorofluorocarbons (HCFC), the hydrofluorocarbons (HFC), etc.

The foaming process can also be of a chemical nature, based on the use of an expansion agent chosen from the chemical components capable of generating cells by decomposition. Both physical and chemical expansion agents as described above can also be used in the foaming processes.

The process for the preparation of cellular structures comprising the use of carbon nanotubes, which can be broken down into three phases, is as follows:

The first phase is the phase of preparing a CNT/polymer composite mixture. This mixture can be prepared by melting in an internal mixer, for example of the Haak type. The mixture thus obtained is ground. This method of preparation is given by way of example in order to demonstrate the invention. All methods for preparation of composite based on polymers, resins and elastomers can be used. For example single- and double-screw extruders, nozzles, static mixers, etc. can be mentioned. The mixture obtained can be used as it is or after dilution, in a matrix, which is compatible or not compatible. In this case the first mixture is called a master batch.

The second phase is the solubilization phase, during which the expansion agent is introduced, which is solubilized in the mixture.

The third phase is the phase of creating cells in the polymer phase by subjecting the mixture to chemical or physical conditions suitable for the expansion agent to carry out its task.

In particular, when the expansion agent is a supercritical fluid, for example CO₂, the latter is introduced under high pressure and is solubilized in the CNT/polymer mixture until reaching a saturation concentration, then the mixture is subjected to a decompression which leads to nucleation and cell growth which are at the origin of the formation of the CNT/polymer composite cellular structures or foam.

The micro-cellular structures obtained have a % CNT by weight in the polymer structure greater than 0.05%, preferably greater than 0.1%, or also preferably comprised between 0.1 and 3%. Preferentially and also for reasons of the cost of formulation, the percentage by weight of carbon nanotubes introduced into the structure is less than 60%, preferably less than 50%, preferably also comprised between 10 and 50% or also comprised between 0.1 and 15%.

The process described above can also be followed by a step during which the polymer is carbonized, followed by a step of graphitization at a high temperature (greater than 1000° C.). In this case the CNT content in the polymer is greater than 2% by weight with respect to the polymer, preferably comprised between 5 and 60% or also comprised between 10 and 50%. A lightweight carbon-containing material having a double porosity is thus obtained: one resulting from the foaming step with the same diameter as the cells and a second associated with the voids left by the removal of the polymer and which is found in the cell walls. This second porosity, which is much smaller, for example less than 5 microns, can be modulated by combining another filler with the CNT such as graphite or any type of fillers which are conductive electrically or thermally or are good insulators. The choice of the CNT content with respect to the additional filler can vary from 0 to 100%, this will depend on the application envisaged and the porosity.

The invention offers the advantage that the lightweight materials obtained have an equivalent density compared to that of polymeric cellular materials without carbon nanotubes while having markedly smaller cell sizes. This makes it possible in particular, to improve the mechanical, insulating or conductive properties of the lightweight material to be envisaged. The presence of CNTs in the polymer has the advantage of performing the task of nucleation agent during the foaming process and thus promoting obtaining cells which are smaller than those of a foam without CNT. Thus it is possible to achieve a reduction of more than 30% in the average diameter d₅₀ of the cells in the polymer structures according to the invention, in relation to that of foams without CNT, with the same bulk density.

Moreover, the properties of electrical and/or thermal insulation or electrical and/or thermal conductivity of the lightweight materials comprising the polymeric cellular structures according to the invention depend on the level of carbon nanotubes incorporated. It is therefore under the ability of the person skilled in the art to choose the correct CNT level for the specifications required.

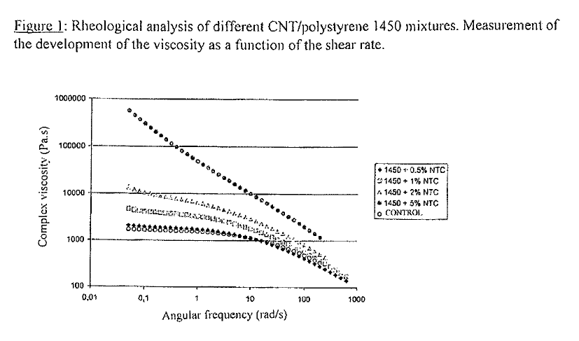

The use of composites based on carbon nanotubes in the foaming process has the advantage of giving the composite good characteristics in the molten condition. This property is evaluated by the viscosity at a low shear rate (see FIG. 1). During expansion, the viscous forces oppose those induced by the gas during expansion of the cells.

The single-porosity lightweight structures according to the invention can be used in the following applications: packaging, insulation, lightweight materials, sealing, etc.

The double-porosity materials can find applications in the manufacture of electrodes, membranes, etc., in the energy storage markets such as batteries, supercapacitors.

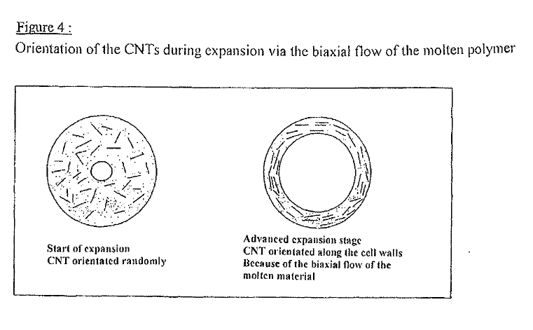

The structures according to the invention can also contain residues of the expansion agent used in the foaming process. The presence of this expansion agent which remains in the cells generally has an impact on the conductivity properties of the final lightweight material, and without being bound by any particular theory, it can be hypothesized that the presence of CNTs in a cellular polymer structure can act as a brake on the diffusion of the expansion agent in particular when the latter is a gas. This could have a positive impact on the insulating or conductive capability of the final lightweight material according to the invention. In fact, the presence of orientated CNT in the cell walls (see FIG. 4) cannot do otherwise than slow down the diffusion of the expansion gas.

### EXAMPLES

The following examples illustrate the present invention without however limiting its scope.

Carbon nanotubes are used which are obtained according to the process described in patent PCT WO 03/002456 A2. These nanotubes have a diameter comprised between 10 and 30 nm and a length>0.4 μm. In the final composition, they are presented in a dispersed form in order to benefit from the properties of the CNTs.

For the reference expanded cellular structure, a polystyrene 1450 is used. Polystyrene 1450 is produced by the company Total Petrochemicals.

Unless indicated otherwise, quantities are expressed by weight.

In these examples, mixtures of polystyrene with different concentrations of CNT, 0.5 and 1% of CNT were tested in a foaming process based on supercritical CO₂ according to the following three-phase outline:

The first is the melting phase. The polymer or composite is placed at a high temperature in a reactor of the autoclave type (generally between 190° C. and 200° C. for a PS) under vacuum to avoid degradation of the polymer; a vacuum pump is connected to the inlet valve of the reactor by a flexible tube. The duration of the melting phase is generally approximately 2 hours.

The second phase is the solubilization phase. After stopping the vacuum pump, the temperature control is adjusted for the solubilization phase. The CO₂ is routed using a pump provided with a cooler. The inlet valve is opened by adjusting the control to the working pressure and by opening the air supply of the pump. The pump starts and the pressure increases in the autoclave. When the working pressure is reached, the inlet valve closes automatically. The duration of the solubilization phase is generally approximately 17 hours. The CO₂ under high pressure is in a supercritical state and is solubilized in the polystyrene until reaching a concentration corresponding to the saturation concentration for the working pressure and temperature.

The third phase is the phase of decompression or foaming of the composite polymer. The temperature control is adjusted to ambient temperature in order to start cooling the autoclave, generally by vortex. A control is adjusted to open the outlet valve, which leads to a depressurisation at a speed imposed by the pressure and the configuration of the pipes. This leads to the nucleation and the cell growth which is at the origin of the foam formation. The interior of the autoclave can be cooled by a more effective method when depressurisation is finished. The reactor is rapidly opened to recover the foams.

Various cellular structures according to the invention are prepared in accordance with the process described above, with variable nanotube contents of 0 to 1%.

In order to study their properties, polystyrene structures containing 0%, 0.5%, and 1% of nanotubes were chosen. These compositions are referenced A, B and C.

### Example 1

In a few mixtures, foams were prepared as a function of the temperature at a CO₂ pressure of 140 bars. The results obtained, in terms of density and cell size, are given in FIGS. 1 to 3 and Table 1.

TABLE 1

| | A | B | C |
|---|---|---|---|
| | reference | invention | invention |
| 135° C. | PS 1450 | PS 1450 + 0.5% | PS 1450 + 1.0% |
| | | CNT | CNT |
| Density (kg/m³) | 42 | 45 | 46 |
| Diameter of the | 128 | 59 | 80 |
| cells d₅₀ (μm) | | | |

### Results of the Tests.

FIG. 1 shows the development of the viscosity as a function of shear rate. The rheological analysis of different polystyrene 1450/CNT mixtures shows the increase in viscosity at a low shear rate. This increase is beneficial for obtaining a micro-cellular structure.

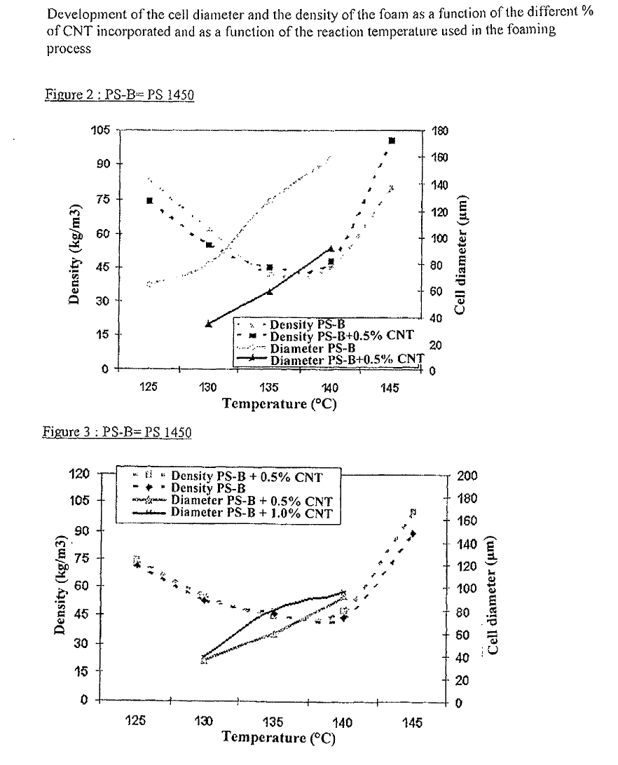

FIGS. 2 and 3 show the development of the cell diameter and the density of the foam as a function of the different % by weight of CNT incorporated and the expansion temperature used in the foaming process.

It can be seen clearly from the results shown in the graphs in FIGS. 2 and 3 and in Table 1 that at 0.5% by weight of CNT added to the PS 1450, the cell diameter is reduced by 51% on average with respect to pure PS 1450, while retaining a constant density. This result clearly reflects the nucleation effect of CNTs, which is reflected by an increase in cell numbers.

Increasing the quantity of carbon nanotubes in the polymer matrix has no further effect on the nucleation. On the other hand, it can allow the thermal conductivity, electrical conductivity and mechanical rigidity to be managed.

1. Cellular polymeric structure comprising carbon nanotubes the percentage of which by weight in the polymer structure is less than 60%, characterized in that the average size of the cells is less than 150 microns.

2. Cellular polymeric structure according to claim 1 characterized in that the average size of the cells is between 20 and 80 microns

3. Structure according to claim 1 having a void volume of at least 50%.

4. Structure according to claim 1 having a bulk density less than 100 Kg/m³.

5. Structure according to claim 1 in which the polymer is selected from the group consisting of thermoplastic or thermosetting (co)polymers, elastomers or resins.

6. Structure according to claim 1, in which the polymer is selected from PVDF, EVAs, PEBAs or PAs.

7. Structure according to claim 1 in which the polymer is a polystyrene.

8. Structure according to claim 1 in which the polymer is a polyurethane.

9. Structure according to one of claim 1 further comprising the residues of an expansion agent.

10. Structure according to claim 9 in which the expansion agent is selected from the group consisting of liquid or gaseous organic or inorganic compounds, solid chemical compounds capable of generating cells by decomposition, gaseous compounds or a mixture thereof.

11. Structure according to claim 1 in which the walls of the cells also comprise pores.

12. Use of a structure according to claim 1 in the fields of food packaging, insulation, lightweight structure materials, manufacture of membranes, electrodes.

13. Process for the preparation of a polymeric cellular structure comprising the steps of a) preparation of a carbon nanotube/polymer composite mixture; b) solubilization of an expansion agent in said mixture; c) subjecting the mixture to chemical or physical conditions for creating cells in the polymeric structure.

14. Process according to claim 13 in which the expansion agent is a supercritical gas.

15. Process according to claim 13 in which the mixture of step c) is subjected to a decompression in order to create the cells.

16. Process according to claim 13 in which the polymer originating from step c) is subjected to a carbonisation followed by a step of graphitization at a temperature greater than 1000° C.

17. Structure according to claim 1 in which the percentage by weight of the carbon nanotubes in the polymer is between 10 and 50%.

18. Structure according to claim 1 in which the percentage by weight of the carbon nanotubes in the polymer is between 0.1 and 3%.

19. Structure according to claim 1 having a void volume of between 50% and 99%.

20. Structure according to claim 1 having a bulk density between 10 and 60 Kg/m³.

21. Process according to claim 14 in which the expansion agent is a selected from the group consisting of supercritical CO₂ or a fluorinated gas selected from the group consisting of chlorofluorocarbons (CFC), hydrochlorofluorocarbons (HCFC) or hydrofluorocarbons (HFC).
